(19) United States
(12) Patent Application Publication
(10) Pub. No.: US 2017/0306790 A1
(43) Pub. Date: Oct. 26, 2017

(54) FUEL SYSTEMS FOR TURBOMACHINES

(71) Applicant: Hamilton Sundstrand Corporation, Charlotte, NC (US)

(72) Inventors: August M. Coretto, Manchester, CT (US); Aaron F. Rickis, Feeding Hills, MA (US)

(21) Appl. No.: 15/134,524

(22) Filed: Apr. 21, 2016

(51) Int. Cl. F01D 21/02; F02C 9/46

(52) U.S. Cl. CPC F01D 21/02; F02C 9/46

(57) ABSTRACT

A fuel system for a turbomachine includes a minimum pressure and shutoff valve (MPSOV) disposed between a fuel source and a fuel nozzle of a fuel system and configured to move between an opened position wherein fuel can flow to the fuel nozzle, and a closed position wherein fuel is prevented from flowing to the fuel nozzle, and a shutdown signal valve (SDSV) operatively connected to the MPSOV and configured to selectively supply a shutdown pressure to the MPSOV in a shutdown state such that the shutdown pressure forces the MPSOV to the closed position.

### BACKGROUND

### 1. Field

The present disclosure relates to turbomachines, more specifically to fuel systems for turbomachines.

### 2. Description of Related Art

In a turbine engine, a shaft shearing is a failure event that needs to be detected and responded to as quickly as possible. Over-speeding of the engine occurs due to instant reduction of resistance associated with shaft shearing. Once an over-speeding condition occurs, fuel flow to the turbine must be shut down as quickly as possible to prevent further damage to the engine and aircraft. It is an architectural challenge to meet the stringent shutdown requirements while trying to maintain lightweight and non-complex systems.

Such conventional methods and systems have generally been considered satisfactory for their intended purpose. However, there is still a need in the art for improved fuel systems for turbomachines. The present disclosure provides a solution for this need.

### SUMMARY

A fuel system for a turbomachine includes a minimum pressure and shutoff valve (MPSOV) disposed between a fuel source and a fuel nozzle of a fuel system and configured to move between an opened position wherein fuel can flow to the fuel nozzle, and a closed position wherein fuel is prevented from flowing to the fuel nozzle, a shutdown signal valve (SDSV) operatively connected to the MPSOV and configured to selectively supply a shutdown pressure to the MPSOV in a shutdown state such that the shutdown pressure forces the MPSOV to the closed position, and a bypass valve (WBV) connected to the MPSOV and SDSV such that when the MPSOV closes, the excess flow will be re-circulated to the pump inlet

The shutdown pressure can be supplied from a main pump flow or any other suitable location. In certain embodiments, the main pump flow is fine filtered.

The SDSV can be a pressure actuated valve and can include a signal port for receiving a shutoff signal pressure. The SDSV can be configured to move between a closed state to an opened state wherein the shutdown pressure can be supplied to the MPSOV when the signal port is exposed to the shutoff signal pressure.

The shutoff signal pressure can be less than shutdown pressure such that a pressure greater or equal to shutdown pressure applied to the signal port can maintain the SDSV in the closed state. The signal port can be operatively connected to an over-speed actuator such that shutdown pressure flows from the over-speed actuator to the signal port when over-speed is detected.

The system can further include a normal pressure line configured to supply a normal pressure to the MPSOV to urge the MPSOV toward the closed position, wherein the normal pressure is insufficient to close the MPSOV in a normal operation. The normal pressure can be a pump interstage pressure. In certain embodiments, the MPSOV can include a normal spring bias to urge the MPSOV toward the closed position, wherein the normal spring bias is insufficient to close the MPSOV in a normal operation.

The WBV can allow excess flow to recirculate to the main pump after the MPSOV is shutoff by the SDSV. In certain embodiments, the WBV and SDSV are actuated by the same signal pressure to decrease operation time.

In accordance with at least one aspect of this disclosure, a method includes determining an over-speed condition of a turbomachine and supplying a shutdown pressure to a minimum pressure and shutoff valve (MPSOV) from an shutdown signal valve (SDSV).

These and other features of the systems and methods of the subject disclosure will become more readily apparent to those skilled in the art from the following detailed description taken in conjunction with the drawings.

### BRIEF DESCRIPTION OF THE DRAWINGS

So that those skilled in the art to which the subject disclosure appertains will readily understand how to make and use the devices and methods of the subject disclosure without undue experimentation, embodiments thereof will be described in detail herein below with reference to certain figures, wherein:

FIG. 1 is a schematic flow diagram of an embodiment of a system in accordance with this disclosure, shown in a normal operating state; and

FIG. 2 is a schematic flow diagram of the embodiment of FIG. 1, shown in a shutdown state (e.g., due to over-speeding).

### DETAILED DESCRIPTION

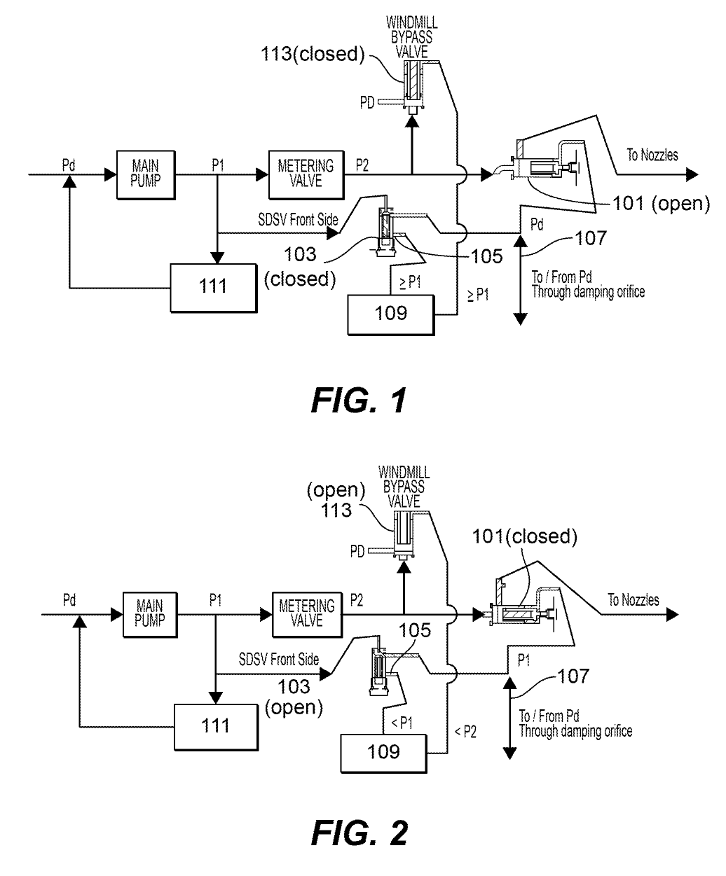

Reference will now be made to the drawings wherein like reference numerals identify similar structural features or aspects of the subject disclosure. For purposes of explanation and illustration, and not limitation, an illustrative view of an embodiment of a system in accordance with the disclosure is shown in FIG. 1 and is designated generally by reference character 100. Other embodiments and/or aspects of this disclosure are shown in FIG. 2. The systems and methods described herein can be used to shut off fuel flow rapidly (e.g., in the event of shaft shearing).

Referring to FIGS. 1 and 2, a fuel system 100 (e.g., and integrated fuel pump control (IFPC)) for a turbomachine includes a minimum pressure and shutoff valve (MPSOV) 101 disposed between a fuel source (not shown) and a fuel nozzle (not shown) of the fuel system 100 and configured to move between an opened position wherein fuel can flow to the fuel nozzle (e.g., as shown in FIG. 1), and a closed position wherein fuel is prevented from flowing to the fuel nozzle (as shown in FIG. 2). The system 100 includes a shutdown signal valve (SDSV) 103 that is operatively connected to the MPSOV 101 and configured to selectively supply a shutdown pressure to the MPSOV 101 in a shutdown state such that the shutdown pressure forces the MPSOV 101 to the closed position (as shown in FIG. 2).

As shown, the shutdown pressure can be supplied from a main pump flow. Any other suitable location for supplying the shutdown pressure is contemplated herein. In certain embodiments, the main pump flow is fine filtered first before being sent through to the SDSV 103.

In certain embodiments, as shown, the SDSV 103 can be a pressure actuated valve and can include a signal port 105 for receiving a shutoff signal pressure. The SDSV 103 can be configured to move between a closed state (e.g., as shown in FIG. 1) to an opened state (as shown in FIG. 2) wherein the shutdown pressure can be supplied to the MPSOV 101, when the signal port 105 is exposed to the shutoff signal pressure.

The shutoff signal pressure can be less than shutdown pressure such that a pressure greater or equal to shutdown pressure applied to the signal port 105 can maintain the SDSV 103 in the closed state. The signal port 105 can be operatively connected to an over-speed actuator 109 (e.g., a solenoid valve) such that shutdown pressure flows from the over-speed actuator 109 to the signal port 105 when over-speed is detected (e.g., after shaft shear).

It is contemplated that the SDSV 103 can be any other suitable valve type (e.g., an electromechanical valve) configured to operate in any suitable manner. It is also contemplated that a shaft shearing event may be directly or indirectly (e.g., via over speeding) sensed in any suitable manner, and SDSV 103 can be actuated (e.g., by a controller connected to a shaft shear/over speed sensor) in any suitable manner.

The system 100 can further include a normal pressure line 107 configured to supply a normal pressure to the MPSOV 101 to urge the MPSOV 101 toward the closed position. However, the normal pressure is insufficient to close the MPSOV 101 in a normal operation and acts as a reference to which the MPSOV will set the minimum pressure. The normal pressure in the normal pressure line 107 can be a pump interstage pressure Pd (e.g., derived downstream of a pressure regulating valve 111 as shown). In certain embodiments, the MPSOV 101 can include a normal spring bias to urge the MPSOV 101 toward the closed position, the normal spring bias and/or the normal pressure being insufficient to close the MPSOV 101 in a normal operation.

In accordance with at least one aspect of this disclosure, a method includes determining an over-speed condition of a turbomachine and supplying a shutdown pressure to a minimum pressure and shutoff valve (MPSOV) 101 from an shutdown signal valve (SDSV) 103. Embodiments of the method can be executed using any suitable hardware (e.g., a memory and processor) and/or software (e.g., associate with an engine controller, for example).

In turbomachines, shutdown can be controlled by the IFPC. In certain conditions, the main turbomachine shaft can shear, causing rapid engine acceleration. One or more sensors can sense the rapid acceleration. In such a case, an engine controller recognizes speed up and sends a shutdown signal to the IFPC. Traditionally, pressure would decay on the front side of the MPSOV 101 after opening a windmill bypass valve (WBV) 113 via an over-speed actuator (e.g., a solenoid), which slowly closes the MPSOV 101 due to a bias on the back side of the MPSOV 101. However, this is a relatively slow decay.

As described herein, the IFPC can activate one or more over-speed actuators 109 (e.g., a solenoid) to operate the SDSV 103 (and along with the WBV 113 in certain embodiments to allow recirculation of excess flow) and decay engine speed and pressure. When operated, the SDSV 103 injects a high pressure to the back side of the MPSOV 101 to rapidly close the MPSOV 101 regardless of the pressure still acting on the front side of the MPSOV 101.

By virtue of utilizing a very small and/or lightweight valve (the SDSV 103) to port high pressure flow to the back of the MPSOV 101, a quick shutdown of a turbine engine can be achieved (in either a normal or over-speed condition). Embodiments as described above can greatly decrease the shutoff time over traditional systems. Also, utilizing a separate SDSV 103 valve allows the system to be lighter because of the minimal flow requirements for the valve. In addition, the separate valve can meet tighter leakage requirements.

The methods and systems of the present disclosure, as described above and shown in the drawings, provide for fuel systems with superior properties including rapid shutoff. While the apparatus and methods of the subject disclosure have been shown and described with reference to embodiments, those skilled in the art will readily appreciate that changes and/or modifications may be made thereto without departing from the spirit and scope of the subject disclosure.

What is claimed is:

1. A fuel system for a turbomachine, comprising:
a minimum pressure and shutoff valve (MPSOV) disposed between a fuel source and a fuel nozzle of a fuel system and configured to move between an opened position wherein fuel can flow to the fuel nozzle, and a closed position wherein fuel is prevented from flowing to the fuel nozzle;
a shutdown signal valve (SDSV) operatively connected to the MPSOV and configured to selectively supply a shutdown pressure to the MPSOV in a shutdown state such that the shutdown pressure forces the MPSOV to the closed position; and
a bypass valve (WBV) connected to the MPSOV and SDSV such that when the MPSOV closes, the excess flow will be re-circulated to the pump inlet

2. The system of claim 1, wherein the shutdown pressure is supplied from a main pump flow.

3. The system of claim 2, wherein the main pump flow is fine filtered.

4. The system of claim 1, wherein the SDSV is a pressure actuated valve and includes a signal port for receiving a shutoff signal pressure.

5. The system of claim 4, wherein the SDSV is configured to move between a closed state to an opened state wherein the shutdown pressure is supplied to the MPSOV, when the signal port is exposed to the shutoff signal pressure.

6. The system of claim 5, wherein the shutoff signal pressure is less than shutdown pressure such that a pressure greater or equal to shutdown pressure applied to the signal port will maintain the SDSV in the closed state.

7. The system of claim 6, wherein the signal port is operatively connected to an over-speed actuator such that shutdown pressure flows from the over-speed actuator to the signal port when over-speed is detected.

8. The system of claim 1, further comprising a normal pressure line configured to supply a normal pressure to the MPSOV to urge the MPSOV toward the closed position, wherein the normal pressure is insufficient to close the MPSOV in a normal operation.

9. The system of claim 8, wherein the normal pressure is a pump interstage pressure.

10. The system of claim 9, wherein the MPSOV further includes a normal spring bias to urge the MPSOV toward the closed position, wherein the normal spring bias is insufficient to close the MPSOV in a normal operation.

11. The system of claim 2, wherein the WBV allows the excess flow to recirculate to the main pump after the MPSOV is shutoff by the SDSV.

12. The system of claim 1, wherein the WBV and SDSV are actuated by the same signal pressure to decrease operation time.

13. A method, comprising:
determining an over-speed condition of a turbomachine; and
supplying a shutdown pressure to a minimum pressure and shutoff valve (MPSOV) from an shutdown signal valve (SDSV).
